(19) United States
(12) Patent Application Publication
(10) Pub. No.: US 2021/0054565 A1
(43) Pub. Date: Feb. 25, 2021

(54) METHOD FOR PRODUCING A BASE STRUCTURE FOR A PAPERMACHINE CLOTHING

(71) Applicant: VOITH PATENT GMBH, Heidenheim (DE)

(72) Inventors: Uwe KOECKRITZ, HEIDENHEIM (DE); Jens KALLENBERG, HERBRECHTINGEN (DE); Michael STRAUB, STEINHEIM (DE); Cedric FITZER, WEISSENHORN (DE); Reinhard HOLL, LAUINGEN (DE)

(73) Assignee: Voith Patent GmbH, Heidenheim (DE)

(21) Appl. No.: 16/979,272

(22) PCT Filed: Jan. 18, 2019
(86) PCT No.: PCT/EP2019/051201

§ 371 Date: Sep. 9, 2020

(30) Foreign Application Priority Data
Mar. 9, 2018 (DE) 10 2018 105 433.5

(51) Int. Cl. D21F 1/00; D21F 7/08; B32B 38/00; B32B 27/34; B32B 27/36; B32B 27/08; B32B 37/00

(52) U.S. Cl. CPC D21F 1/0036; D21F 1/0081; D21F 7/083; B32B 38/004; B32B 27/34; B32B 2037/0092; B32B 27/08; B32B 37/0076; B32B 2377/00; B32B 2367/00; B32B 27/36

(57) ABSTRACT

A method for producing a base structure of a clothing for use in a machine producing and/or processing a fiber web. The clothing base structure is a laminate formed of at least two layers and the layers are formed substantially from polymer material. The method includes the following steps: locally melting the polymer material of the two layers by the action of radiation from a radiation source and pressing the polymer material of the two layers onto each other. The polymer material of the two layers is thereby guided into a press nip formed by two press rolls, forming an inlet gap, and the radiation is directed into the inlet gap.

The present invention relates to a method for producing a base structure of a clothing for use in a machine, in particular a paper-making machine, which produces and/or processes a fibrous web, wherein the clothing base structure has a laminate which is formed from at least two layers, and the layers are formed substantially from polymer material, wherein the method comprises the following steps: locally melting the polymer material of the two layers by irradiation from a radiation source, and pressing the molten polymer material of the two layers together, wherein, for this purpose, the polymer material of the two layers is guided, forming a run-in gap, into a press nip formed by two pressing rolls.

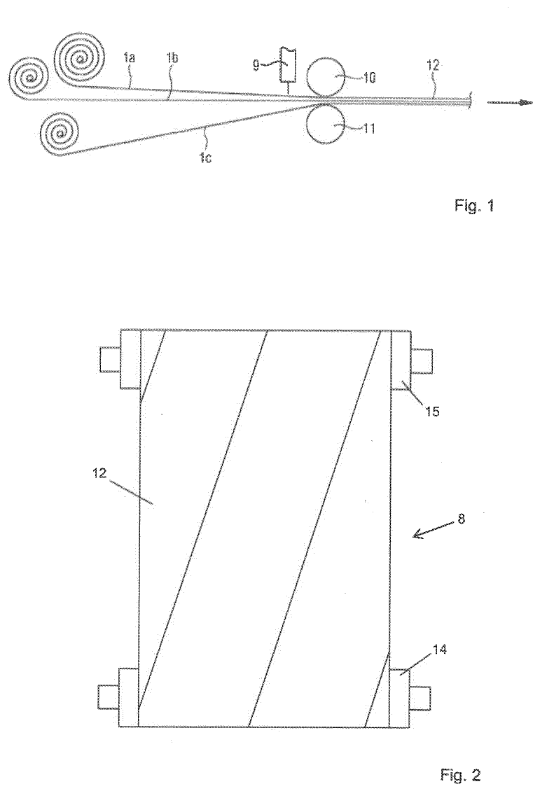

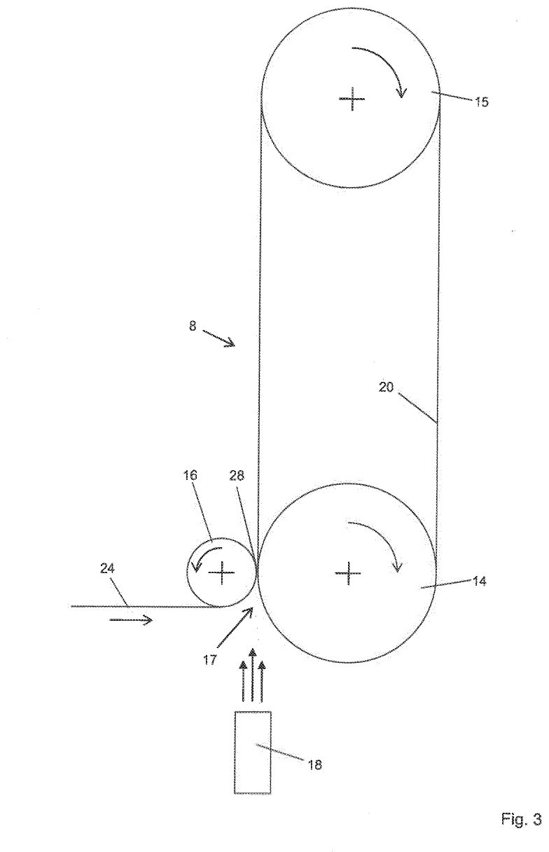

A production method of said type is known from the document WO 2015/185278 A1. As shown in FIG. 1, WO 2015/185278 A1 discloses the formation of a laminate 12 from multiple band-like polymer films 1a, 1b, 1c in the form of roll goods, by virtue of said polymer films being melted by irradiation by means of a radiation source 9, for example a laser, and, shortly thereafter, being pressed together in the still-molten state by means of an action of force in a nip formed by two pressing rolls 10, 11. In the subsequent method step shown in FIG. 2, the laminate 12, which has a smaller width than the width of the base structure 8 for a paper-making machine clothing to be produced therefrom, is wound around two mutually spaced-apart winding rolls 14, 15 in a helically advancing manner in the direction of the width of the base structure 8 to be produced. A base structure 8, present as an endless strip, for a paper-making machine clothing is generated in this way. Subsequently, holes are also formed into the base structure in order to allow water drainage through these.

A disadvantage of the method known from the prior art is that the radiation must firstly penetrate through the first polymer film 1a in order to reach the second polymer film 1b arranged therebelow in order to melt said second polymer film. With regard to the third polymer film 1c, the laser beam must furthermore also penetrate through the second polymer film 1b. Here, there is the risk of the first polymer film 1a, which faces toward the radiation source 9, being heated too intensely, which has an adverse effect on the strength of the polymer film 1a. This is the case in particular if the polymer films have been stretched in order to increase their tensile strength. In order to have the radiation energy act primarily on those surfaces of the polymer films 1a, 1b, 1c which are to be brought into contact with one another, it is common practice for these to firstly be coated with an absorbent material for the radiation, in particular laser radiation, for example with soot. However, the coating constitutes an additional process step, which makes the method correspondingly complex and increases the susceptibility to errors.

A further disadvantage in the case of the known production method consists in that the helically wound web-like laminate 12 must be connected together at its two side edges, for example by means of a laser-fused seam, in order to provide the finished clothing base structure 8 with the required inherent stability. A further process step is thus necessary for the production of the clothing base structure 8. It is furthermore the case that the clothing base structure 8 can have different characteristics in the region of the seam than in its other regions, which can under some circumstances lead to undesired marks in the fibrous web to be produced.

It is an object of the present invention to eliminate or alleviate at least some of the above-stated problems in the case of the known production method.

Said object is achieved by means of a production method as claimed in claim 1. The subclaims relate to advantageous refinements of the invention.

According to the invention, the generic production method mentioned in the introduction is further developed in that the radiation is directed into the run-in gap. By virtue of the fact that the radiation is oriented directly into the run-in gap, it does not need to firstly penetrate through the polymer material of one of the two layers in order to reach the polymer material of the other layer. Instead, said radiation acts directly at the surfaces, facing toward one another, of the two layers to be connected. In this way, the energy can be introduced in a targeted manner into the material at the location at which the material is to be melted, without the need for a medium which is especially absorbent for the radiation to be applied to said surfaces for this purpose. This simplifies the production process. Here, the radiation source is preferably oriented such that its main radiation direction points directly into the run-in gap. Here, the main radiation direction may run orthogonally with respect to an imaginary plane which comprises the axes of the two pressing rolls. In this way, the melting of the polymer occurs even closer to the press nip than in the known production method, such that it is possible to work with less energy, because the molten polymer material no longer has the opportunity to cool on the path to the press nip. As a radiation source, use may preferably be made of a laser, that is to say a radiation source which radiates coherent light.

It is preferably the case that, firstly, one of the two layers is produced by virtue of a first band-like film strip, the width of which is smaller than the width of the clothing base structure to be produced, being wound helically around two mutually spaced-apart winding rolls. This corresponds substantially to the method from the prior art described above with regard to FIG. 2, wherein, however, for cost reasons, the first band-like film strip is preferably itself not formed from a laminate but rather is a substantially monolithically produced film. For example, it may be an extruded film which has been intensely stretched in a longitudinal direction for the purposes of increasing the tensile strength.

An advantage of the helical winding consists in that it is possible for base structures for paper-making machine clothings of different length and width to be manufactured relatively easily and thus inexpensively from the same starting material, that is to say from the band-like film strip. Furthermore, in order to make the clothing base structure endless, it is not necessary to provide a transverse seam thereon, which not only simplifies the production process but also reduces the risk of markings in the fibrous web to be produced on the clothing.

One positive further development of the invention provides that the other of the two layers is also produced by virtue of a second band-like film strip, the width of which is smaller than the width of the clothing base structure to be produced, being wound helically around two mutually spaced-apart winding rolls. Here, it is preferably the case that, at the same time, the second band-like film strip is laminated onto the first layer.

By contrast to the situation described in WO 2015/185278 A1 as cited in the introduction, it is thus not the case that a laminate in the form of a band-like strip is firstly formed and subsequently helically wound; rather, the laminate is formed for the first time when the first layer of the base structure has already been fully formed. This has the advantage that the laminating of the second layer onto the first layer ensures not only a bond between these two layers but at the same time also eliminates the need for a separately formed bond between the two side edges of a respective band-like film strip. Thus, although it is possible to maintain the above-stated advantages arising from a helical winding, the production method can be greatly simplified.

Alternatively, the advantages just described may self-evidently also be realized by virtue of two or more winding heads being operated directly in series, such that the second winding head can already start to apply the second band-like film strip to the already partially wound first band-like film strip, with the first layer formed by the first band-like film strip however not yet having been fully formed. In this way, the production process can be advantageously accelerated.

In order that a separately formed bond between the two side edges of a respective band-like film strip can be omitted, the layers composed of band-like film strips must suitably overlap. For this purpose, it is proposed that the side edges of the first band-like film strip run parallel but offset with respect to the side edges of the second band-like film strip. Alternatively, it is proposed that the side edges of the first band-like film strip do not run parallel with respect to the side edges of the second band-like film strip, that is to say the side edges are oriented with an angle with respect to one another. It is pointed out at this juncture that a “band-like film strip” is to be understood preferably to mean a film strip which has a substantially rectangular basic shape. The thickness of the film strip is in this case negligible in relation to the dimensions of the side edges of the film strip, and is preferably less than 1 mm, more preferably less than 300 μm. Furthermore, the dimension of the two side edges of the film strip is several times greater than the dimension of the two end edges of the film strip.

As already mentioned, it is advantageous from a manufacturing aspect if the two mutually adjacent side edges of the helically wound first and/or second band-like film strip have no direct force-fitting, form-fitting or cohesive connection to one another. The two band-like film strips assume their form as a helical winding exclusively as a result of the connection, in particular the fusing, of the second band-like film strip to the first band-like film strip.

The equipment setup for the production of the clothing base structure can be particularly simple if the two winding rolls for the winding of the first band-like film strip are identical to the two winding rolls for the winding of the second band-like film strip, wherein, preferably, one of the two winding rolls is furthermore identical to one of the two pressing rolls. A total of only three rolls is thus required.

Preferably, for the connection of the two layers, no auxiliary substances, in particular no adhesive and/or material which is particularly absorbent for the radiation, such as for example soot, are introduced between said layers. This saves time and costs in the production process. Where this is however necessary, in particular in order to obtain the required strength characteristics in the bond, it may however be advantageous to introduce such auxiliary substances, in particular adhesive and/or material which is particularly absorbent for the radiation, such as for example soot, between the layers to be connected. In particular, a material for plasma or corona activation may be provided.

The clothing base structure can additionally be provided with advantageous capabilities in a relatively simple manner if the polymer material of the first layer differs from the polymer material of the second layer. For example, the polymer material of the first layer may be formed substantially from polyamide or PA, and the polymer material of the second layer may be formed substantially from polyethylene terephthalate or PET, wherein the first layer is preferably arranged radially at the inside in relation to the second layer in the fully produced clothing base structure. PA has greater abrasion resistance than PET, which is of importance in particular for the running side of the clothing situated radially at the inside, whereas PET is more dimensionally stable than PA. If the finished laminate of the base structure has more than two layers, it is also possible for further layers composed of different or the same materials to be provided between a radially outermost layer composed of PET and a radially innermost layer composed of PA. In other words, it is of importance merely that the radially outermost layer of the laminate is formed from PET as main material and the radially innermost layer of the laminate is formed from PA as main material.

Furthermore, at least one layer may also be reinforced by means of fibers. For example, glass fibers may be embedded in a matrix composed of PP or PET. If the finished laminate of the base structure has more than two layers, then it is particularly advantageous if the or at least one central layer is reinforced with fibers. Since the clothing circulates in endless fashion specifically during the intended operation of the machine, it is subject to different loads at different points during the circulation. Here, it is the case that the clothing is subjected to lower tensile or compressive loads in the central layer than in the outer layers. It is thus possible for the or at least one central layer to advantageously be used to accommodate less flexible, fiber-reinforced material, which is particularly highly suitable for transmitting high tensile forces in a machine direction.

The layers may however alternatively or additionally also differ with regard to characteristics other than the polymer main material. For example, the layers may be pigmented and may differ with regard to their colors. It is also possible for other optical characteristics, such as fluorescence or reflection characteristics, to significantly differ in the various layers, for example through the addition of special additives. The advantage consists in that these layers can then serve as wear indicators. If one layer has been almost fully abraded, then the layer situated under it shows through, which can be easily identified either visually using the naked eye or with the aid of corresponding electronic means. The identification can even be reliably performed during the ongoing operation of the machine for the production or processing of a fibrous web, and can thus provide the operator with a timely indication that the clothing must be repaired or exchanged in order to prevent a failure or losses in quality in the fibrous web.

As is also described in detail in WO 2015/185278 A1, the method according to the invention preferably furthermore comprises the step of forming a multiplicity of passage openings into the laminate formed from at least two layers. Said passage openings serve for allowing the fibrous web to be drained as required, that is to say for the discharging of liquid out of the fibrous web through the base structure. The passage openings may for example be punched or bored, in particular bored using a laser.

A further aspect of the present invention relates to a clothing for use in a machine which produces and/or processes a fibrous web, wherein the clothing comprises a base structure which has been produced in accordance with the method described above. For example, the clothing may be the clothing in the forming section or in the press section of a paper-making or cardboard-making machine. In the case of the clothing being used as a forming screen, the clothing base structure, which is composed of the laminate comprising multiple layers and which is provided with passage openings, can already substantially constitute the finished product, that is to say the forming screen. In the case of the clothing being used as a press felt, it is necessary for at least one felt layer to also be applied to the base structure. Furthermore, the clothing may for example also be used as a drying screen.

Preferably, the clothing base structure has a laminate which comprises at least two layers, wherein the two layers are each composed of a helically wound band-like film strip, and wherein the two layers are areally fused to one another and no auxiliary substances are present between the two layers.

It is very particularly preferably the case here that the two side edges of a respective band-like film strip have no direct force-fitting, form-fitting or cohesive connection to one another.

The invention will be discussed in more detail below on the basis of schematic drawings, which are not true to scale. In the drawings:

FIG. 3 is a schematic illustration of a device for producing a clothing base structure,

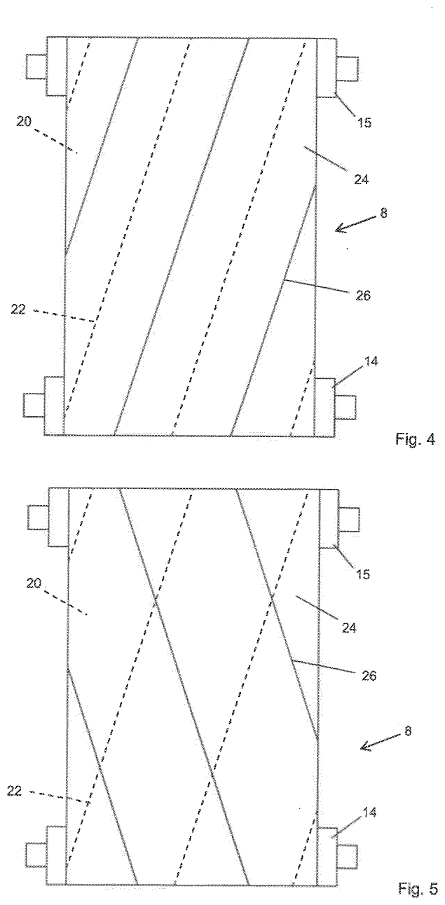

FIG. 4 is a first embodiment of a clothing base structure,

FIG. 5 is a second embodiment of a clothing base structure.

FIG. 3 shows a device for carrying out the method according to the invention for producing a base structure 8 of a clothing for use in a machine which produces and/or processes a fibrous web. The clothing may for example be the forming screen of a paper-making machine. The device comprises, as main elements, three rolls, specifically a first winding roll 14, a second winding roll 15 and a first pressing roll 16, and a radiation source 18, for example a laser. In the case of this arrangement, the first winding roll 14 simultaneously functions as a second pressing roll. The respective direction of rotation of the three rolls 14, 15, 16 during intended use is indicated by a curved arrow, and the respective axis of rotation thereof is indicated by a cross, in FIG. 3.

In a first process step, the first pressing roll 16 is however not yet required. In this method step, a first band-like film strip 20 is wound helically around the two winding rolls 14 and 15 until the desired width of the clothing base structure 8, which may substantially correspond to the width of the final clothing, has been attained. For variation of the desired length of the clothing base structure 8, the spacing between the two winding rolls 14, 15 can be varied. In this way, a first, radially inner layer for a laminate of the clothing base structure 8 to be produced is formed. This first layer has substantially the same appearance as the arrangement described with regard to FIG. 2, wherein the laminate 12 is however to be imagined as having been replaced by the first band-like film strip 20.

At this juncture, it is pointed out once again that the figures are purely schematic illustrations. In reality, the spacing between the winding rolls 14, 15 may be considerably greater, and the width of the laminate 12 or of the band-like film strip 20 may be considerably smaller, such that the two winding rolls 14, 15 are enwound with a significantly greater number of windings than that illustrated in the figures. It is also possible for the angle with which winding is performed, that is to say the angle between side edge 22 (see FIGS. 4 and 5) and the axis of rotation of one of the two winding rolls 14, 15 to be different, in particular smaller.

The first band-like film strip 20 is preferably an extruded polyamide film with a substantially monolithic structure. Here, it is itself thus not a laminate comprising multiple layers, as in WO 2015/185278 A1, wherein this would also be possible.

In a second process step, a second layer is laminated onto the first layer radially at the outside. The second layer is in this case composed of a second band-like film strip 24, which is likewise wound helically by means of the two winding rolls 14, 15. During the winding of the second band-like film strip 24, the polymer material of the first layer and the polymer material of the second band-like film strip 24 which forms the second layer are locally melted at their respectively facing surfaces and are immediately subsequently pressed against one another in order to fuse together and thus form a laminate. Said surfaces come into contact with one another in a press nip 28 formed by the two pressing rolls 14, 16, where said surfaces are pressed against one another with a predetermined force. The polymer material is melted at said surfaces by radiation, in particular laser radiation, from the radiation source 18. Said radiation source is positioned such that the radiation is, according to the invention, directed into a run-in gap 17, that is to say into the gap which is formed by the first layer and the second band-like film strip 24 which forms the second layer, which gap opens out in the press nip 28. In the present exemplary embodiment, the radiation, illustrated by arrows in FIG. 3, from the radiation source 18 is, with regard to its main radiation direction, oriented substantially orthogonally with respect to an imaginary plane which comprises the axes of rotation of the two press rolls 14, 16. The radiation thus passes exactly locally to the location where it is required.

The second band-like film strip 24 may in this case be wound around the two winding rolls 14, 15 such that its side edges 26 run parallel but with a spacing with respect to the side edges 22 of the first band-like film strip 20 of the first layer, as illustrated in FIG. 4. Alternatively, the second band-like film strip 24 may however also be wound around the two winding rolls 14, 15 such that its side edges 26 do not run parallel to the side edges 22 of the first band-like film strip 20 of the first layer but rather cross these, as illustrated in FIG. 5. In FIGS. 4 and 5, the first band-like film strip 20 is illustrated, by way of its side edges 22, only using dashed lines, because it is concealed by the second band-like film strip 24 which forms the second layer.

The two side edges 22 of the first band-like film strip 20 preferably lie together in a butt-jointed manner without being directly connected to one another in form-fitting, force-fitting or cohesive fashion. Likewise, it is preferable for the two side edges 26 of the second band-like film strip 24 to lie together in a butt-jointed manner without being directly connected to one another in form-fitting, force-fitting or cohesive fashion. The two band-like film strips thus remain in their wound form by virtue of the two layers being laminated areally on one another.

The second band-like film strip 24 is preferably an extruded polyethylene terephthalate film with a substantially monolithic structure. Thus, the second layer of the laminate is composed of a different polymer material than the first layer. In this way, it is possible for different material characteristics to be advantageously combined in the laminate. Furthermore, the two layers may be differently pigmented in order to function as a wear indicator. The two layers preferably have a layer thickness of 500 μm or less. The total thickness of the base structure amounts to preferably 1200 μm or less. The two film strips may be stretched, preferably in their main extent direction, in order to increase the strength. Furthermore, the laminate may also comprise more than two layers, wherein a third layer may be applied to the second layer in substantially the same way as the second layer was applied to the first layer. The same applies to all further layers.

After the completion of the laminate, this may also be provided with a multiplicity of passage bores which provide the base structure with the capability of draining a fibrous web transported on the finished clothing. The passage bores may for example be introduced by punching or by boring. For the latter, the use of a laser is particularly favorable.

### LIST OF REFERENCE DESIGNATIONS

1a, 1b, 1c Polymer films
8 (Clothing) base structure
9 Radiation source
10, 11 Pressing rolls
12 Laminate
14, 15 Winding rolls
16 Pressing roll
17 Run-in gap
18 Radiation source
20 First band-like film strip
22 Side edge of the first band-like film strip
24 Second band-like film strip
26 Side edge of the second band-like film strip
28 Press nip

1-15. (canceled)

16. A method for producing a base structure of a clothing for use in a machine for producing and/or processing a fibrous web, the clothing base structure having a laminate formed from at least two layers, which are formed substantially from polymer material, the method comprising:
locally melting the polymer material of the at least two layers by irradiation from a radiation source to form molten polymer material;
guiding the at least two layers into a press nip formed between two pressing rolls, the press nip having a run-in gap, and pressing the molten polymer material of the two layers together in the press nip between the pressing rolls; and
directing the radiation of the radiation source into the run-in gap.

17. The method according to claim 16, which comprises producing one of the at least two layers as a first band-shaped film strip, a width of which is smaller than a width of the base structure of the clothing to be produced, and helically winding the strip around two mutually spaced-apart winding rolls.

18. The method according to claim 17, which comprises producing another of the at least two layers as a second band-shaped film strip, a width of which is smaller than the width of the clothing base structure to be produced, and helically winding the strip around two mutually spaced-apart winding rolls, and, at the same time, laminating the second band-shaped film strip onto a first layer formed by the first band-shaped film strip.

19. The method according to claim 18, wherein side edges of the first band-shaped film strip run parallel but offset with respect to the side edges of the second band-shaped film strip.

20. The method according to claim 18, wherein side edges of the first band-shaped film strip do not run parallel with respect to side edges of the second band-shaped film strip.

21. The method according to claim 18, wherein two mutually adjacent side edges of the helically wound first band-shaped strip and/or second band-shaped film strip have no direct force-fitting, form-fitting, or cohesive connection to one another.

22. The method according to claim 18, wherein the two winding rolls for winding the first band-shaped film strip are identical to the two winding rolls for winding the second band-shaped film strip.

23. The method according to claim 22, wherein one of the two winding rolls is identical to one of the two pressing rolls.

24. The method according to claim 16, wherein, for connecting the two layers, no auxiliary substances are introduced between the layers.

25. The method according to claim 24, wherein no adhesive and/or any material that is absorbent for the radiation is introduced between the layers.

26. The method according to claim 24, which comprises connecting the layers without introducing soot therebetween.

27. The method according to claim 16, wherein the polymer material of the first layer differs from the polymer material of the second layer.

28. The method according to claim 27, wherein the polymer material of the first layer is formed substantially from polyamide, and the polymer material of the second layer is formed substantially from polyethylene terephthalate.

29. The method according to claim 28, which comprises arranging the first layer radially inside relative to the second layer in the finished clothing base structure.

30. The method according to claim 28, wherein the first layer has a different visual characteristic from the second layer.

31. The method according to claim 28, wherein the first layer has a different color than the second layer.

32. The method according to claim 16, which further comprises forming the laminate formed of at least two layers with a multiplicity of passage openings.

33. A clothing for a machine that produces and/or processes a fibrous web, the clothing comprising: a base structure which has been produced by the method according to claim 16.

34. The clothing according to claim 33, wherein said clothing base structure has a laminate of at least two layers, each of said at least two layers being formed of a helically wound band-shaped film strip, and said two layers being areally fused to one another, with no auxiliary substances present between said at least two layers.

35. The clothing according to claim 34, wherein said band-shaped film strips have side edges, and two side edges of a respective band-shaped film strip have no direct force-fitting, form-fitting or cohesive connection to one another.
